(19) United States
(12) Patent Application Publication
(10) Pub. No.: US 2008/0066933 A1
(43) Pub. Date: Mar. 20, 2008

(54) Rotary fire sprinkler

(76) Inventor: Yuetian Yan, Foshan (CN)

Correspondence Address: LAW OFFICES OF CLEMENT CHENG, 17220 NEWHOPE STREET #127, FOUNTAIN VALLEY, CA, 92708, US

(21) Appl. No.: 11/975,823

(22) Filed: Oct. 22, 2007

Related U.S. Application Data
(63) Continuation of application No. PCT/CN2005/001150, filed on Apr. 25, 2005.

(30) Foreign Application Priority Data
Apr. 25, 2005 (CN) 200510034231.5

(51) Int. Cl. A62C 31/05; A62C 37/42

(52) U.S. Cl. 169/38

(57) ABSTRACT

A fire sprinkler has an inlet pipe and a water nozzle body. The water nozzle body has a water nozzle cover and a water mouth component. A stop valve core, the upper end of which is a stop valve, is mounted inside the water nozzle body. A supporting rack is mounted at a water nozzle lower end. A glass heat sensitive element is vertically mounted in the supporting rack. A stop valve core which is supported via the glass heat sensitive element drops to bias the stop valve from the water inlet, which is situated at the lower end of the induction pipe. A force rotates the water nozzle body on the ball bearing. The centrifugal force from nozzle body rotation provides a parabolic water spray shape for achieving larger area fire extinguishing effect.

This application is a continuation of PCT application entitled A Rotary Temperature Sensitive Sprinkler Fire Extinguishing Apparatus having a publication number WO 2006/114024 A1 filed by YAN, Yuetian on Jul. 29, 2005, the disclosure of which is incorporated herein by reference, and which claims the priority of Chinese application 200510034231.5 filed Apr. 25, 2005. The PCT application has an international application number of PCT/CN2005/001150.

### AREA OF TECHNOLOGY

This invention is in the field of fire sprinklers, namely a rotary heat sensitive fire extinguishing fire sprinkler.

### BACKGROUND

China ZL200420015438.9 publication shows one kind of large area spray fire-fighting unit. The fire-fighting unit includes a water inlet pipe and a nozzle body. The nozzle body has a nozzle cover, and the nozzle cover has the central hollow area equipped with holes. The hole aperture and the water inlet pipe are of comparable caliber, the water inlet pipe terminal has a tube shoulder which extends outwardly. After the water inlet pipe passes through the nozzle to cover the interior, which passes the hole, the tube shoulder and the nozzle cover form a ring-like crevice, and in the crevice lays a group of ball bearings. The nozzle cover with the nozzle interior is equipped with a water cavity, the water cavity and the water inlet pipe connects, on the nozzle to establish has a group of arranged water outlets, the water outlets and the water cavity connect. This equipment may use its own water power to carry on spraying, and has large area protection. The nozzle body rotates nimbly, but this equipment itself does not have the automatic heat sensitive installment so that with a fire-alarm it can start self propelled with spray movement, and thus its use is insufficiently convenient and prompt.

### BRIEF SUMMARY OF THE INVENTION

A rotary temperature sensitive fire extinguishing sprinkler comprises an inlet pipe and a water nozzle body. The water nozzle body has a water nozzle cover and a water mouth component. A stop valve core, the upper end of which is a stop valve, is mounted inside the water nozzle body. A supporting rack is mounted at a water nozzle lower end. A glass heat sensitive element is vertically mounted in the supporting rack. One end of the glass heat sensitive element is inserted into a supporting rack adjusting screw, and the other end props up the lower end of the stop valve core. When firing, the glass heat sensitive element automatically ruptures. The stop valve core which is supported via the glass heat sensitive element drops to bias the stop valve from the water inlet, which is situated at the lower end of the induction pipe. Then, water immediately enters the chamber and sprays out from the outlet. Simultaneously, a force is applied to the water nozzle body to rotate it on the ball bearing. The centrifugal force from nozzle body rotation provides a parabolic water spray shape for achieving larger area fire extinguishing effect.

### SUMMARY OF THE INVENTION

The object of the invention lies in providing a kind of heat sensitive function to automatically activate a spray that also sprays a large area, and work nimbly as a rotary system heat sensitive fire extinguishing sprinkler. In order to reach the above goal, this invention provides the rotary heat sensitive fire extinguishing sprinkler with a water inlet pipe and the nozzle body. The nozzle body has a nozzle cover with a water mouth component. The nozzle cover middle portion has a through aperture, connected to the water inlet pipe. The water inlet pipe has an outwardly extending pipe shoulder. The water inlet pipe passage nozzle cover upper portion forms an annular crevice with the water inlet pipe outwardly extending pipe shoulder. In the crevice lay a set of ball bearings. The nozzle body interior is equipped with a water cavity. The water cavity connects to the water inlet pipe passage. On the nozzle top is established a group of a turbine flat leaf arranged water outlets. The flat leaf arranged water outlets connect to the water cavity. The nozzle water body is equipped with a water valve stopper. The water valve stopper has an upper end that seals the water inlet from the nozzle water body core area. The water stopper valve seals up to the water inlet pipe. The lower end of the water valve stopper protrudes out of the nozzle water body bottom. Underneath the nozzle is mounted a supporting rack. The supporting rack has a vertical stroke receiving the glass heat sensitive part. The glass heat sensitive part end inserts in the supporting rack the adjustment screw hole. In the adjustment screw hole is installed the adjusting screw. The other end of the glass heat sensitive part goes against the water stopper valve core lower extremity.

When this utility invention is installed in a building space at a high position, after fire-alarm activation when ambient temperature achieved has reached a defined value, the glass heat sensitive part can automatically break. After the glass heat sensitive part breaks, the center support shoots out leaving a space. The water stopper valve core drops after the glass heat sensitive part breaks and thus causes the water stopper valve to unseal from the water inlet pipe lower part. Then the water passes through the water inlet pipe and the lower part of the water inlet to enter the nozzle body and immediately the water cavity. Because on the nozzle there is formed a group of leaf shaped passages on the water outlet, the water through the water outlet high speed blowout simultaneously causes the nozzle to receive the water leakage reverse to flush the pressure. The nozzle body makes an autorotation movement via the ball bearing. The nozzle body revolves and the centrifugal force which produces a high speed parabolic shape water spray, and thus forms an omni-directional water spray to achieve a large area fire fighting effect.

This invention defines the water stopper valve top to assume a cone shape. The water stopper valve lower part has an area slightly larger than the water inlet pipe lower part. The water inlet outside portion has a seat to receive a seal with the water stopper valve via the O-ring seal. The water stopper valve used assumes a cone shaped structure providing advantage to this fire-fighting unit operation when the water current may flow fast in the nozzle body interior water cavity. Outside established the seal along on O-ring, may play the seal role, prevented this fire-fighting unit does not work when water leakage.

This invention has a water inlet pipe with a top end tube establishing at a central place an aperture to pass water flow via a water flow adjustment disk. The disc has an aperture that can be sized for adjusting water flow.

The disk may be sized according to different needs. Different sizing of the pass hole aperture in each fire-fighting unit may provide many adjustments for adapting to the needs of the water inlet pipe and the nozzle body configuration in which different water spray current capacity or speed of flow fire for various fighting conditions. This invention is equipped with one stopper. The stopper lodges on the water inlet pipe, its function to stop the fire-fighting unit from operating until shifted relative to the water inlet pipe and the nozzle body.

In summary, this invention is in the field of structural science providing a highly automated, large spray area, flexible function and like characteristics.

### BRIEF DESCRIPTION OF THE DRAWINGS

FIG. 1 is a side perspective view of the nozzle.

FIG. 2 is a top view of the nozzle.

FIG. 3 is a bottom view of the nozzle.

FIG. 4 is cross-section partial structure schematic view.

FIG. 5 is a cross-section with the glass heat sensitive part broken and with the device in running condition.

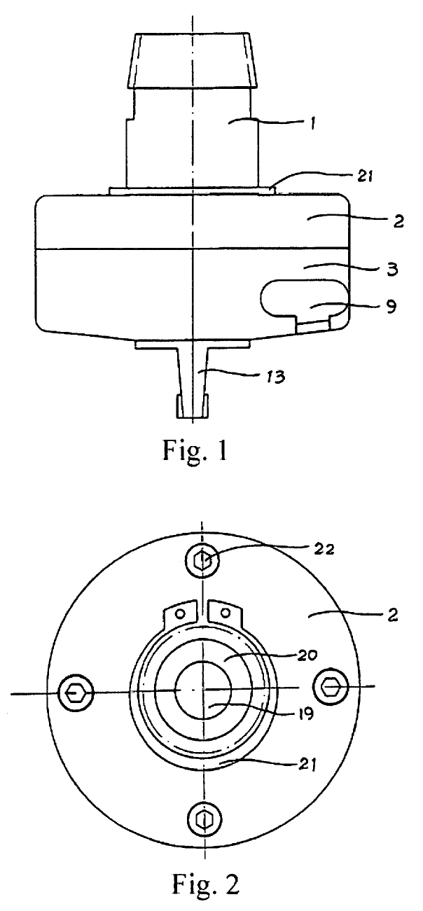

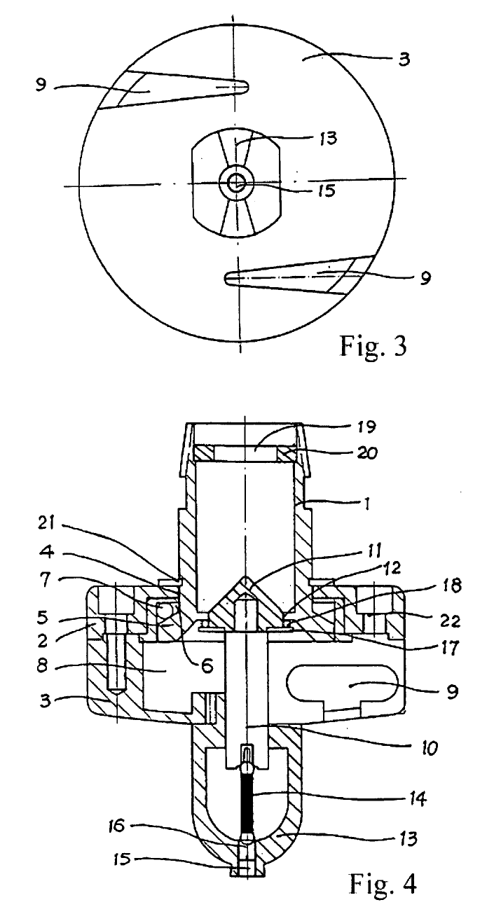

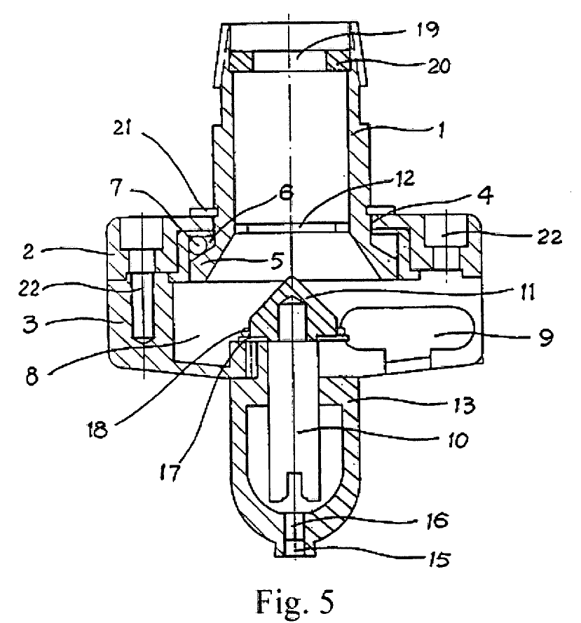

### DETAILED DESCRIPTION OF THE PREFERRED EMBODIMENT

This invention provides a rotary system heat sensitive water spraying fire-fighting unit including: a water inlet pipe 1, and a nozzle body. The nozzle body comprises a nozzle body cover 2 and nozzle 3. The nozzle cover 2 and the nozzle 3 are fixed by intervening through screw 22 secured connections. The nozzle cover 2 middle is equipped with pass hole 4. Pass hole 4 aperture and the water inlet pipe 1 have similar caliber so that the nozzle cover can rotate on the water inlet pipe. The water inlet pipe 1 has a bottom end with an outwardly extending tube shoulder 5. The water inlet pipe 1 passes through the nozzle cover 2 at a nozzle cover upper aperture which is pass hole 4, which fits over the shoulder 5, which fits with the nozzle cover 2 interior to form a ring-like crevice 6. In crevice 6, lay a group of ball bearings 7. The nozzle body interior is equipped with a water cavity 8. The water cavity 8 has fluid through connection with the water inlet pipe 1 if in running mode. The nozzle 3 has a group assuming a leaf-shape arrangement of water outlet 9. The water outlet 9 connects with the water cavity 8. The nozzle body has one water stopper valve core 10. The water stopper valve core 10 has an upper extreme end which is the water valve 11. The water stopper valve 11 seals up the water inlet pipe 1 at a lower part of the water inlet 12. The water stopper valve core 10 lower extremity passes through the nozzle 3 base wall to be exposed. Under nozzle 3 is mounted a supporting rack 13. The supporting rack 13 vertically holds a glass heat sensitive part 14. The glass heat sensitive part 14 bottom end inserts in supporting rack 13 and adjustment screw hole 15. The adjustment screw hole 15 has installed the adjusting screw 16. The glass heat sensitive part 14 other top end abuts and retains the water valve core 10 lower extremity.

This invention implementation example has water stopper valve 11 to assume a cone shape. The water stopper valve 11 lower part has an area slightly bigger than the water inlet pipe lower part so that the water inlet 12 outside surface 17 has a seal via O-ring 18. When the water valve core 10 drops, the flat portion of the water stopper valve 11 rests against the bottom wall of the nozzle 3.

In this invention implementation example water inlet pipe 1 has another top tube end formed with a central passage defined as hole 19 through water flow adjustment disk 20.

This invention implementation example water inlet pipe 1 is equipped with the nozzle body formed on the exterior connection with one lock spring 21. Lock spring 21 locks on a groove formed on the water inlet pipe 1. If the device is in running condition and the nozzle body is rotating, the lock spring 21 biases against the vertical force caused by the water spray.

1. A rotary heat sensitive fire extinguishing sprinkler comprising: a water inlet pipe (1) and a nozzle body, wherein the nozzle body further comprises a nozzle body cover (2) and a nozzle (3), wherein a nozzle body cover (2) middle portion has a passage hole (4), wherein passage hole (4) and water inlet pipe (1) have a similar caliber, wherein water inlet pipe (1) has an end that has a tube shoulder (5) which extends outwardly, wherein after the water inlet pipe (1) passes through the nozzle body cover (2) on to pass a hole on tube shoulder (5) so that cover (2) forms with the nozzle interior a ring-like crevice (6), wherein the crevice (6) holds a group of ball bearings (7); wherein the nozzle body interior is equipped with a water cavity (8), wherein the water cavity (8) connects with the water inlet pipe (1), the nozzle (3), a group of formed leaf-shaped arranged water outlet (9), wherein the water outlet (9) fluidly connects with the water cavity (8), wherein a nozzle stopper comprises a water stopper valve core (10), wherein an upper end of water stopper valve core (10) has a water valve (11), wherein water stopper valve (11) seals up to the water inlet pipe (1) at a lower part water inlet (12), wherein the water stopper valve core (10) lower extremity passes through a nozzle (3) base to be exposed externally; wherein underneath the nozzle (3) is equipped a supporting rack (13), wherein supporting rack (13) has a vertically mounted glass heat sensitive part (14), wherein glass heat sensitive part (14) has a bottom end inserted in the supporting rack (13) in an adjustment screw hole (15), wherein the adjustment screw hole (15) is installed with an adjusting screw (16), wherein a glass heat sensitive part (14) top end goes against a water stopper valve core (10) lower end.

2. The rotary heat sensitive fire extinguishing sprinkler according to claim 1, wherein: water stopper valve (11) has a cone shape, wherein a water stopper valve (11) lower part has an area slightly bigger than the water inlet pipe lower part water inlet (12) outside surface (17), wherein outside surface (17) establishes a seal with O-ring (18).

3. The rotary heat sensitive fire extinguishing sprinkler according to claim 1, wherein: water inlet pipe (1) has a central hollow place with passage hole (19) and flow adjustment piece (20).

4. The rotary heat sensitive fire extinguishing sprinkler according to claim 1, wherein: the water inlet pipe (1) is equipped with the nozzle body shaped to allow an exterior connector, namely one lock spring (21), wherein lock spring (21) locks on water inlet pipe (1).

5. A rotary heat sensitive fire extinguishing sprinkler comprising:
a. a water inlet pipe;
b. a nozzle body cover, wherein the nozzle body cover has a top opening receiving the water inlet pipe;
c. a nozzle body, wherein the nozzle body is joined to the nozzle body cover by screws;
d. a water stopper;
e. a glass heat sensitive element held below the nozzle and mounted so that breaking of the glass heat sensitive element releases the water stopper from its seat on the water inlet pipe;
f. a pair of water outlets on the nozzle body arranged so that water expelled from the water inlet pipe, through the top opening, through the nozzle body, past the water stopper would bias the nozzle body in rotation around a central axis.

6. The rotary heat sensitive fire extinguishing sprinkler according to claim 5, wherein the water stopper has a stopper valve having a cone shape, wherein a water stopper valve lower part has an area slightly bigger than the water inlet pipe, wherein an outside surface establishes a seal against O-ring.

7. The rotary heat sensitive fire extinguishing sprinkler according to claim 5, wherein the water inlet pipe has a central hollow portion with a passage hole and flow restrictor disk.

8. The rotary heat sensitive fire extinguishing sprinkler according to claim 5, wherein the water inlet pipe is equipped with the nozzle body shaped to allow an exterior connector, namely a lock spring, wherein the lock spring locks on an external surface of the water inlet pipe.
